(19) United States
(12) Patent Application Publication
(10) Pub. No.: US 2025/0228230 A1
(43) Pub. Date: Jul. 17, 2025

(54) INSECT TRAP

(71) Applicant: United Industries Corporation, Earth City, MO (US)

(72) Inventor: Alex J. Wall, St. Louis, MO (US)

(21) Appl. No.: 19/017,354

(22) Filed: Jan. 10, 2025

Related U.S. Application Data
(60) Provisional application No. 63/620,312, filed on Jan. 12, 2024.

(51) Int. Cl. A01M 1/02; A01M 1/10

(52) U.S. Cl. CPC A01M 1/02; A01M 1/106

(57) ABSTRACT

An insect trap includes a base and a lid, the base having an inner cavity configured to receive a refillable container that can be filled with an insect attractant. The lid may have a plurality of openings that allow access to the inner cavity, for insects to enter through. Each of the plurality of openings may have a chamfered surface to facilitate a landing space for insects. The plurality of openings have a first opening and a second opening that opens into the inner cavity of the base, housing an insect attractant.

### CROSS-REFERENCE TO RELATED APPLICATION

This application claims benefit to U.S. Provisional Patent Application No. 63/620,312 filed Jan. 12, 2024, and titled, “INSECT TRAP,” the disclosure of which is hereby incorporated by reference in its entirety.

### BACKGROUND

This disclosure relates generally to insect traps and, more particularly, to a refillable insect trap for attracting and catching flying insects.

Flying insect traps are devices designed to capture and control the population of airborne pests, such as flies, mosquitoes, and gnats. These traps utilize various mechanisms to attract and entrap insects, ranging from sticky surfaces to ultraviolet light sources. One known insect trap design involves the use of UV light, which attracts insects towards the trap, where they are either zapped by an electric grid or caught on a sticky surface. Another known insect trap type employs pheromones or bait to lure insects into a confined space. While these traps have proven effective in many cases, they also pose challenges and limitations that impact their overall efficiency.

Attractants are needed for the efficacy of flying insect traps by enticing pests towards the trapping mechanism. Various attractants are employed to lure flying insects, and their effectiveness often depends on the specific species being targeted. One commonly used attractant is ultraviolet (UV) light, which mimics the wavelengths attractive to many flying insects, especially nocturnal ones like moths and mosquitoes. Pheromones, chemical substances emitted by insects to communicate with each other, are another powerful attractant. These can be synthesized and strategically placed in traps to mimic the scent of a potential mate or a suitable breeding or feeding location. Additionally, some traps use food-based attractants or specific scents that mimic the odors emitted by decaying organic matter, appealing to insects seeking a food source or breeding site. The development and combination of these attractants are some of the considerations in optimizing the performance of flying insect traps, enhancing their ability to attract and capture target pests effectively.

There are also challenges to known designs when it comes to attracting pests. Often, the attractant or lure inside of the trap is not enough to get the insect to enter the trap. Therefore, a trap that is more attractive to insects is desired.

One challenge with current flying insect trap designs is the need for constant maintenance. Sticky surfaces can quickly become saturated, losing their effectiveness, and requiring frequent replacement, contributing to a significant amount of waste.

Furthermore, the issue of bycatch is a significant concern in flying insect traps. While these devices aim to target specific pests, they often inadvertently capture beneficial insects, such as bees and butterflies. This unintended consequence can have negative impacts on local ecosystems and disrupt pollination processes. Striking a balance between capturing harmful pests and preserving beneficial insects is a persistent challenge in the development of effective and environmentally friendly flying insect traps. Innovations in trap design and technology are desired to address these challenges and create more sustainable solutions for insect control.

It is against this background that the present invention is made.

### SUMMARY

The present disclosure relates generally to insect traps for flying insects. More specifically, the present disclosure relates to an insect trap with a perforated lid comprising a plurality of openings, and a base with a refillable portion that may be filled with an insect attractant.

In an aspect, the insect trap may have a base and a lid. The base may include a first end and an opposite second end defining a longitudinal axis. The base may have a plurality of walls extending between the first end and the second end, forming an inner cavity defined by the plurality of walls and the second end. Within the inner cavity, there may be a refillable container configured to receive insect bait.

In an example, the lid may be coupled to the first end of the base and enclose the inner cavity. The lid defines a plurality of openings allowing access into the inner cavity, each of the plurality of openings having an inlet end defined on an exterior surface of the lid and an outlet end. An elongated middle channel section may extend between the inlet end and the outlet end. The outlet end of the plurality of openings may at least partially extend into the first end of the base.

In another example, the inlet end of the plurality of channels may be chamfered such that a transition section of the inlet end, directly adjacent the exterior surface, has an angle between 15° and 45° relative to the exterior surface.

In an example, the transition section of the inlet end may have a 30° angle relative to the exterior surface, and an opening area of the inlet end at the transition section that is larger than an opening area of the outlet end. In embodiments, the plurality of openings may include at least a first opening and a second opening, the first opening having a different shape and size than the second opening.

In another example, the lid may have a top end that defines the plurality of openings, the plurality of openings being less than half of a total surface area of the top end. The second end of the base defines an exterior cavity, with a post that is configured to removably couple to the base at the exterior cavity. Additionally, the insect trap may further include a hook that is configured to removably couple to the base at the exterior cavity. In embodiments, either the post, or the hook, or neither may be used with the insect trap.

In another example, the hook may at least partially extend along one of the plurality of walls at the base.

In another example, the elongated middle channel section of the plurality of openings may taper inward from the inlet end towards the outlet end. In an embodiment, the plurality of openings may extend substantially parallel to the longitudinal axis.

In an example, the insect trap may have a base including a first end and an opposite second end defining a longitudinal axis, and a plurality of walls extending between the first end and the second end. The second end and the plurality of wall define a refillable container removably disposed within the inner cavity of the base, the refillable container being configured to hold insect bait, and an open top end of the refillable container is positioned higher than the first end of the base. The insect trap may further include a lid configured to removably couple to the first end of the base and enclose the interior cavity, the lid defining a plurality of openings allowing access to the inner cavity. In embodiments, each of the plurality of openings may have an inlet end at an exterior surface of the lid, an outlet end, and an elongate channel extending between the inlet end and the outlet end. Each of the plurality of openings extend substantially parallel to the longitudinal axis with the outlet end disposed within the refillable container, and the inlet end of the plurality of openings may be larger than the outlet end.

In another example, the lid may include latches to removably couple to the first end of the base.

In another example, the inlet end is chamfered and has a transition section adjacent the exterior surface with an angle of about 30° relative to the exterior surface.

In another example, at least some of the plurality of openings may be ellipses. Additionally, the lid may have a thickness, a longitudinal length of the elongate channel of the plurality of openings larger than the thickness of the lid.

In another example, the lid does not form a seal against the open top end of the refillable container.

In another example, the second end of the base includes a seat, the seat supporting the refillable container, and the seat defines an exterior cavity, the insect trap further including a post or a hook, each configured to couple to the seat at the second end of the base in a snap fit connection.

In an example, at least a portion of the exterior surface of the lid is a dark color. In one embodiment, the lid, portion of the lid, or entire insect trap may be dark gray. In other embodiments, the lid, portion of the lid, or entire insect trap may be black, or another suitable dark color.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular examples of the present disclosure and therefore do not limit the scope of the present disclosure. The drawings are not to scale and are intended for use in conjunction with the explanations in the following detailed description. Examples of the present disclosure will hereinafter be described in conjunction with the appended drawings, wherein like numerals denote like elements.

FIG. 1 is an exploded, perspective view of an exemplary insect trap.

FIG. 2 is a cross-sectional view of the insect trap of FIG. 1.

FIG. 3A is a front, perspective view of the insect trap shown in FIG. 1 with a post.

FIG. 3B is a back, perspective view of the insect trap shown in FIG. 1 with a hook.

FIG. 4 is a perspective view of the insect trap shown in FIG. 1.

FIG. 5A is a bottom view of the insect trap shown in FIG. 1.

FIG. 5B is a top view of the insect trap shown in FIG. 1.

FIG. 6 is a perspective view of a top of the insect trap shown in FIG. 1.

FIG. 7A is another perspective view of a first side of the top of the insect trap show in in FIG. 1.

FIG. 7B is another perspective view of a second side of the top of the insect trap showing in FIG. 1.

FIG. 8 is a perspective view of a base and a refillable container of the insect trap shown in FIG. 1.

FIG. 9 is a perspective view of the base of the insect trap shown in FIG. 1, with the refillable container removed.

FIG. 10 is a cross-sectional view of the insect trap of FIG. 1.

FIG. 11 is another cross-sectional view of the insect trap of FIG. 1.

FIG. 12A is a perspective view of the hook of the insect trap of FIG. 1.

FIG. 12B is a second perspective view of the hook of the insect trap of FIG. 1.

FIG. 13A is a bottom view of the hook of the insect trap of FIG. 1.

FIG. 13B is a top view of the hook of the insect trap of FIG. 1.

FIG. 14A is a perspective view of the post of the insect trap of FIG. 1.

FIG. 14B is a second perspective view of the post of the insect trap of FIG. 1.

FIG. 15A is a bottom view of the post of the insect trap of FIG. 1.

FIG. 15B is a top view of the post of the insect trap of FIG. 1.

FIG. 16A is a top view of an insect trap with an 8-bubble design.

FIG. 16B is a top view of an insect trap with a lattice design.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible embodiments for the appended claims.

Throughout this description, references to orientation (e.g., front(ward), rear(ward), top, bottom, first, second, back, right, left, upper, lower, etc.) of the components of the insect trap relate to their position when standing upright on an underlying surface and are used for ease of description and illustration only. No restriction is intended by use of the terms regardless of how the components of the insect trap are situated on its own. As used herein, the terms “axial” and “longitudinal” refer to directions and orientations, which extend substantially parallel to a centerline of the component or system. Moreover, the terms “radial” and “transverse” refer to directions and orientations, which extend substantially perpendicular to the centerline of the component or system. The term “refillable” may include various means of refilling or replacing aspects of the insect trap, including but not limited to a separate replacement refillable container or pod, refilling the refillable container once removed, or adding the liquid or solid insect attractant to the refillable container or pod while it is still inserted in the insect trap.

In examples described herein, an insect trap includes a base, and a lid. The base of the insect trap may be configured to house an inner cavity, capable of receiving a refillable container. The refillable container may be filled with an insect attractant or lure, which attracts the flying insect, trapping them in the refillable container, and drowning them. The insect trap attracts flying insects not only through the attractant/lure but also due to the opening geometry and color of a plurality of openings on the lid of the insect trap.

The opening geometry may be a lattice design and may have a large elongated elliptical shape with pointy ends that are flanked on either side with triangular shape openings. These openings may be finished on the edge with a chamfer. The chamfer provides additional visually hard edges to attract flying insects. Specifically, the chamfer may show increased efficacy in attracting house flies. Additionally, the flying insects are attracted to darker colors. The lid, including the plurality of openings may be molded such that it may have darker coloring around the plurality of openings, the central top of the lid, or the entire insect trap itself to further attract house flies. The chamfer on the edge of the plurality of openings provides two hard edges that attract flying insects before the attractant/lure draws them into the insect trap.

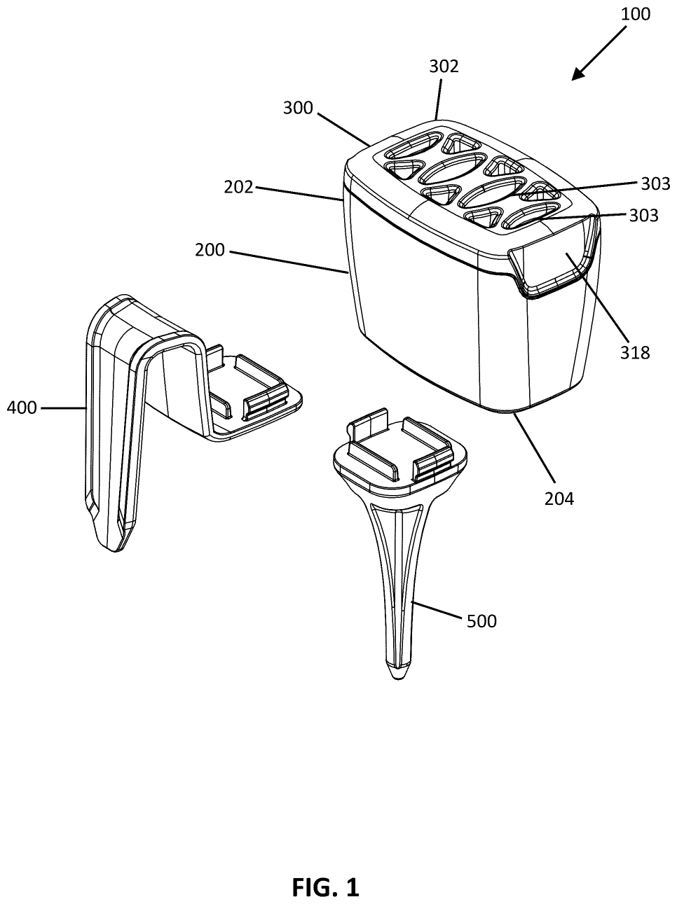

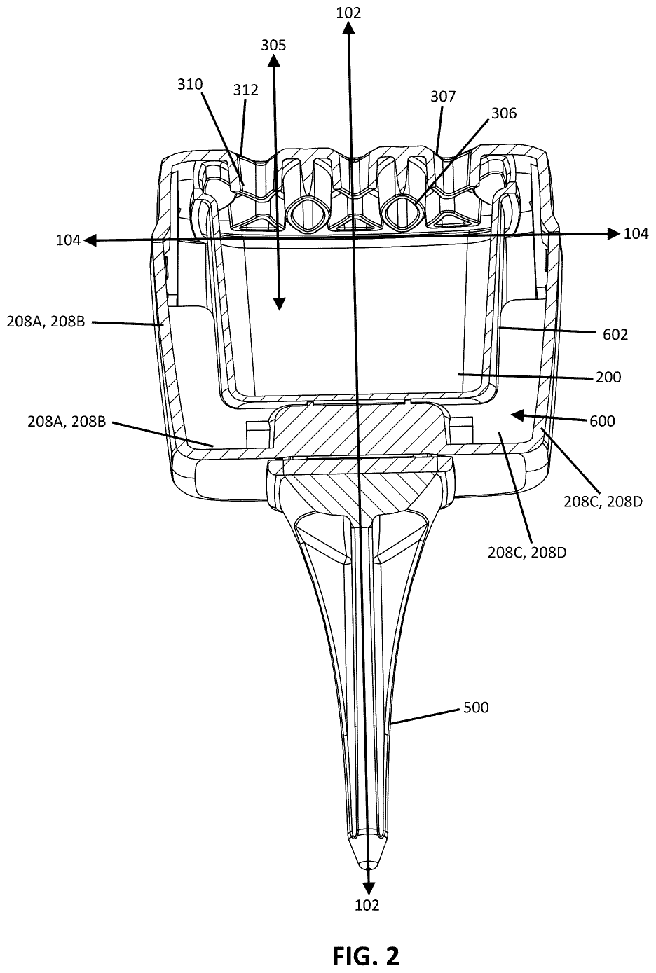

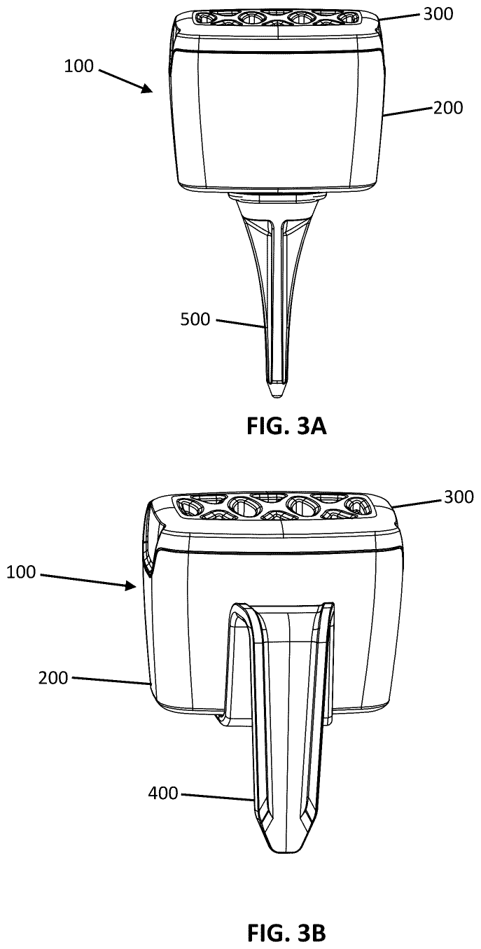

FIG. 1 is an exploded, perspective view of an insect trap 100. FIG. 2 is a cross-sectional view of the insect trap 100. FIGS. 3A and 3B are perspective views of the insect trap 100. Referring concurrently to FIGS. 1, 2, 3A, and 3B, the insect trap 100 includes a base 200, a lid 300, and optionally a hook 400, or a post 500. The base 200 may have a first end 202 and a second end 204. The first end 202 of the base 200 is configured to mate with the lid 300. The lid 300 may have a top end 302 and a bottom end 320. The bottom end 320 includes one or more latches 318 that are configured to removably couple the lid 300 to the first end 202 of the base 200. The top end 302 of the lid 300 may have a plurality of openings 303. The hook 400 and the post 500 are configured to removable mate with the second end 204 of the base 200. In some embodiments, the optional hook 400 may be replaced with a clip, or another mechanism to secure the trap to a variety of structures and surfaces.

The base 200 of the insect trap 100 at least partially defines an inner cavity 600, capable of receiving a refillable container 602. The refillable container 602 may be filled with an insect attractant or lure, which attracts the flying insect, trapping them in the refillable container 602. The insect trap 100 traps the flying insects within the inner cavity 600, and the refillable container 602 may contain a composition. When the composition is a liquid, the composition optionally includes sodium lauryl sulfate which breaks the surface tension of the fluid in the refillable container 602, coats the wings of the flying insects, and leads to drowning. The insect trap 100 attracts flying insects not only through the attractant/lure but also due to the opening geometry and color of the openings 303 on the lid 300 of the insect trap 100. The opening geometry may be a lattice design and may have a large elongated elliptical shape with pointy ends that are flanked on either side, with triangular shape openings that are spaced between and on opposite sides of the lid 300. As such, the openings 303 may have first openings 303a that have a different size and/or shape than second openings 303b. In other examples, the openings 303 may all have equal sizes and/or shapes. The openings 303 may be finished on an edge at the top end 302 with a chamfer. The chamfer provides visually hard edges to attract flying insects. Additionally, the lid 300 and the opening pattern may be molded such that it could have darker coloring around the openings 303, the central top of the lid 300, or the entire insect trap 100 itself to further attract house flies.

The first end 202 and the second end 204 of the base 200 are located on opposite ends of the base 200 and define a longitudinal axis 102. The second end 204 of the base 200 defines a bottom wall and the base 200 includes a plurality of walls (208A-D) that extend between the first end 202 and the second end 204 defining the inner cavity 600. In some embodiments, the base 200 may have one wall, for example if the trap 100 is shaped as a circle, three walls if the base is shaped as a triangle, four walls if the base is shaped as a square or rectangle, or more than four walls if the base is shaped as a polygon. In the example, the base 200 is an open top container body that is sized and shaped to receive the refillable container 602. In an aspect, the base 200 has a substantially rectangle shaped cross-section with a pair of major walls 208A, 208C and a pair of minor walls 208B, 208D. It is appreciated that the base 200 may have any other cross-sectional shape as required or desired such as square, polygonal, etc.

Each of the plurality of openings 303 on the lid 300 has a centerline axis 305 that is oriented substantially parallel to the longitudinal axis 102. The openings 303 are spaced across the longitudinal axis 102 on a transverse plane 104 running perpendicular to the longitudinal axis 102. For example, the first openings 303a are elongated between the major walls 208A, 208C, while spaced apart from each other between the minor walls 208B, 208D. The second openings 303b are disposed adjacent the major walls 208A, 208C, while also spaced apart from each other between the minor walls 208B, 208D. In the example, the plurality of openings 303 are defined by an elongated channel 307 extending substantially parallel to the longitudinal axis 102 and that define the centerline axis 305. The elongated channel 307 includes a first opening 304 and a second opening 306. The first opening 304 is on the top end 302 of the lid 300, while the second opening 306 is found on the bottom end 320 of the lid 300. The first opening 304 forms an inlet 312 for the openings 303 and the second opening 306 forms an outlet 310 for the openings 303. As such, the openings 303 facilitate access into the inner cavity 600 of the insect trap 100 for insects.

In an example, the lid 300 may have a thickness which is the longitudinal length of the elongated channel 307 of the plurality of openings 303 larger than the thickness of the lid 300. In another example, the lid 300 does not form a seal against the top end of the refillable container 602.

As depicted in FIGS. 3A and 3B, the insect trap 100 may include either the post 500 (FIG. 3A), or the hook 400 (FIG. 3B). In either embodiment, each of the hook 400 and the post 500 are configured to removably couple to the insect trap 100 on the second end 204 of the base 200. The post 500 may be advantageous for outdoor uses that involve sticking the insect trap 100 in the ground or another surface, or within the soil of an indoor plant. Conversely, the hook 400 may be helpful for using the insect trap 100 in a windowsill, or another space with a surface to attach the hook to. It is appreciated, that the insect trap 100 can also be utilized without the post 500 or the hook 400 and with the second end 204 of the base 200 resting on top of an underlying surface.

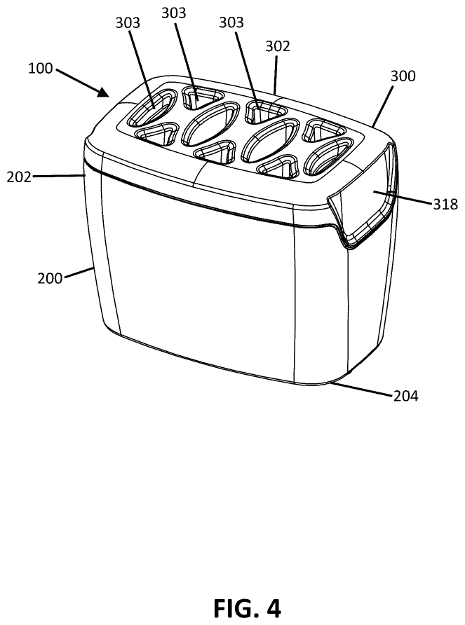

FIG. 4 depicts the insect trap 100 without the hook 400 or post 500 attached (shown in FIGS. 3A-3B). In this configuration, the insect trap 100 is freestanding and does not require but may optionally include the hook 400 or the post 500 when suitable. In operation, the refillable container 602 (shown in FIG. 2) is configured to hold insect attractant and is disposed within the base 200. In some embodiments, the lid 300 removably couples to the first end of the base 202 so that the openings 303 facilitate insect movement towards the insect attractant and capture within the insect trap 100. The lid 302 includes one or more latches 318 that are configured to mate with the first end 202 of the base 200. In the example, the latches 318 are configured to couple to the minor walls 208B, 208D of the base 200. The latches 318 may include a recessed exterior surface to facilitate coupling and removing the lid 302 to the base 200. In some embodiments, the refillable container 602 is unitary with the lid 300 where a user removes the lid and the refillable container 602 and places a new refillable container 602 on top of the base 200. In some embodiments, the lid 300 is formed as a unitary piece with the base 200. This may be beneficial for embodiments where the trap 100 is designed as a single use trap and not refillable.

In some embodiments, the lid 302 may be connected to the refill container 602 of the trap, and replaced or sold as a single unit to prevent spills and create an easier user experience. The lid 302 and refill container 602 would be a single refill assembly to place into the base 200 as a tray, with the insect attractant already included. In another embodiment, the insect attractant may include a gel or sticky substance on the surface of the refill container 602 to increase longevity by not allowing evaporation, or slowing the rate of evaporation.

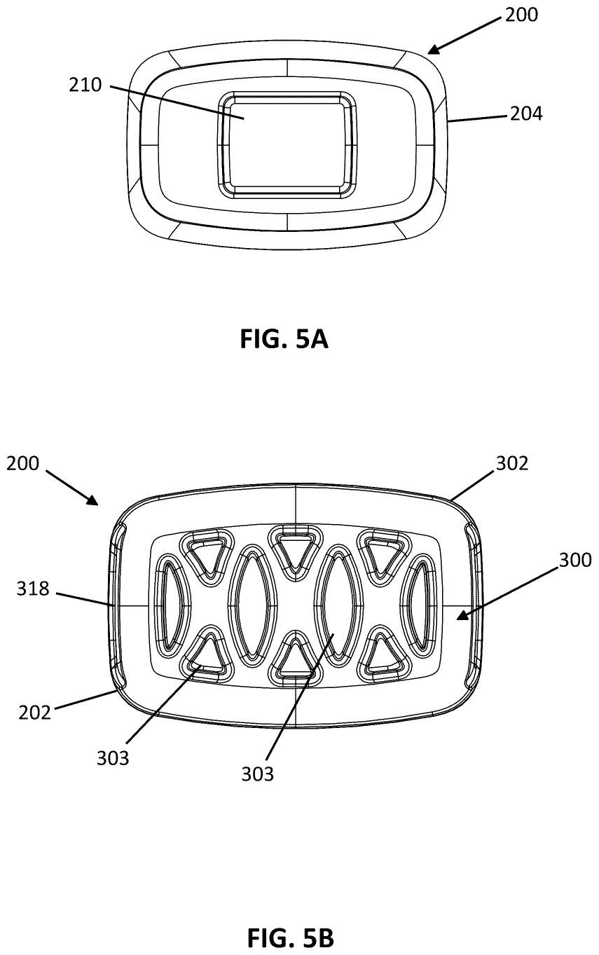

FIGS. 5A and 5B are bottom, and top views of the insect trap. Referring first to FIG. 5A, the second end 204 forms the bottom wall of the base 200. The second end 204 includes a seat 210 that is an external recessed cavity of the base 200. The seat 210 is optionally configured to support the refillable container 602 (shown in FIG. 2) when it is housed within the base 200. Additionally, the seat 210 is configured to enable the post 400 or the hook 500 to couple to the base 200 as required or desired. In the example, the seat 210 is aligned along the longitudinal axis 102 (shown in FIG. 2). In some embodiments, the attractant is added or refilled by replacing refillable container 602 with another refillable container. In other embodiments, the attractant may be added or refilled by pouring more attractant into the bottom of the base 200. In other embodiments, the trap 100 is designed as a single use trap that is not refilled.

Turning next to FIG. 5B, the first end 202 of the base 200 is configured to support the lid 300. The one or more latches 318 are located on opposite sides of the lid 300 and on the minor walls of the base 200. The one or more latches 318 on the lid 300 are configured to enable the lid 300 to removably couple to the top of the base 202. In other examples, the latches 318 may be disposed on the major walls as required or desired. As seen in FIG. 5B, the plurality of openings 303 are through the body of the lid 300 with the inlet 312 at the top end 302 of the lid 300. The plurality of openings 303 may be in a variety of shapes including but not limited to circles, ellipses, squares, triangles, ovals, rectangles, and other suitable shapes. The plurality of openings 303 may also vary in size, and in number. For example, the lid 300 may have 3 openings, 6 openings, 9 openings, 12 openings, or a number of other configurations. The plurality of openings 303 may be evenly spaced or spaced sporadically on the top end 302 of the lid 300. Generally, the openings 303 facilitate allowing insect access into the inner cavity 600 of the insect trap 100 while restricting insects from escaping the inner cavity 600 once therein. Additionally, the openings 303 facilitate allowing insects to be baited by the insect attractant therein (e.g., enabling smells, odors, and the like to escape).

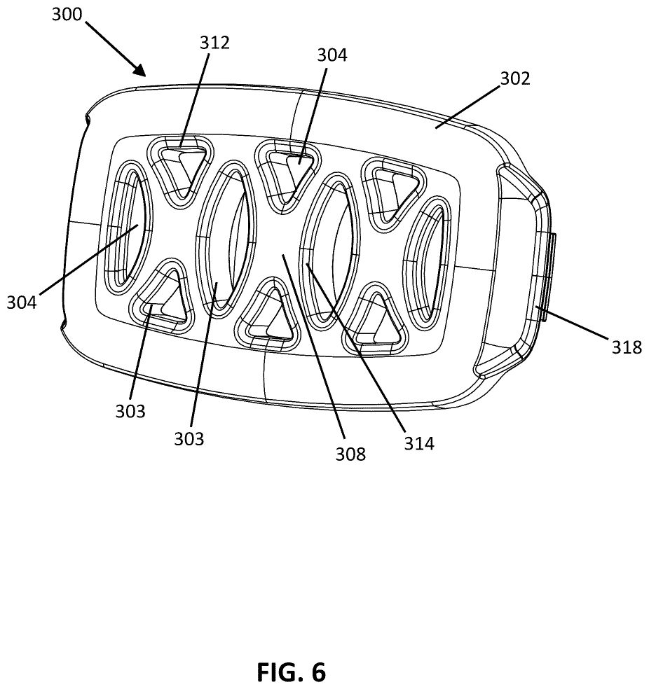

FIG. 6 is a perspective view of the lid 300 of the insect trap 100 (shown in FIG. 4). The lid 300 of the insect trap 100 has a body with the top end 302 and the opposite bottom end 320. On the top end 302 of the lid 300, there is an exterior surface 308 from which the plurality of openings 303 extend from. Exterior surface 308 may be an inset into the lid 300, as shown in FIG. 5B. This allows for the exterior surface 308 to be a different color from the rest of the lid 300. In alternative embodiments, exterior surface 308 can be a unitary part of the lid 300, for example, if the exterior surface 308 and the lid 300 are the same color. The inlet 312 of the openings are defined in the exterior surface 308 and the channel 307 extends from the top end 302 towards the bottom end 320. A transition section 314 of the inlet 312 is formed between the exterior surface 308 and the channel 307. In the example, the transition section 314 is formed by a chamfer at the intersection of the exterior surface 308 and the inlet 312. In an aspect, the transition section 314 may be at an angle of between 15° and 45° relative to the exterior surface.

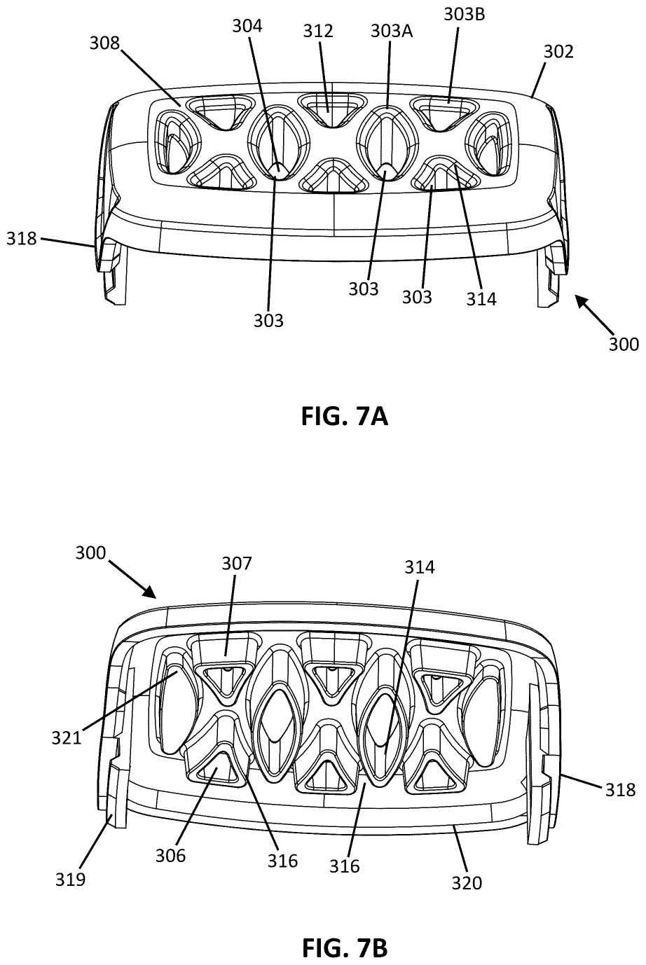

FIGS. 7A and 7B are a top and bottom view of the lid 300 of the insect trap. The lid 300 may be configured to couple to the first end 202 of the base 200 and enclose the inner cavity 600 as described above in reference to FIGS. 1 and 2. In the example, the latches 318 have a cantilevered arm with a distal end defining a hook 319. The hook 319 is configured to snap fit connect to a corresponding recess defined within the base 200. The plurality of openings 303 allow access into the inner cavity 600, and each of the plurality of openings 303 has the inlet end 312 defined on the exterior surface 308 of the top end 302 of the lid 300. The openings 303 also have the outlet end 310 defined at the bottom end 320 of the lid 300. The elongated middle section channel 307 extends between the inlet end 312 and the outlet end 310. The channels 307 project from a bottom surface of the top wall of the lid 300 such that the openings 303 are elongated along the longitudinal axis 102 (shown in FIG. 2).

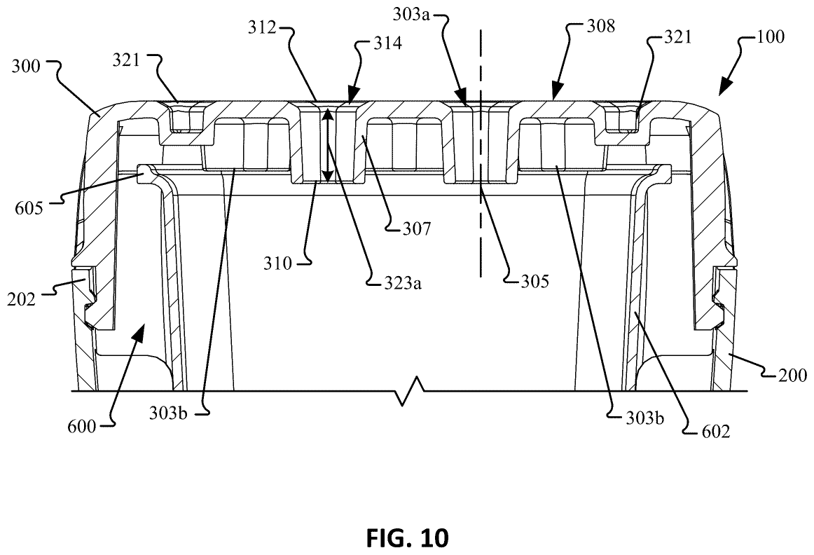

In one example, at least some of the first openings 303a may be ellipses in cross-sectional shape. Ellipse shapes make it more difficult for flying insects to escape the insect trap 100 once they have entered through the inlet 312, because of the narrowing of the channel 307. In the example, the inlet 312 has an opening area that is larger than the opening area of the outlet 310. As such, the channel 307 tapers inwardly from the inlet 312 towards the outlet 310. With the outlet 310 smaller than the inlet 312 most insects to have difficulty getting out or think they cannot get out due to the space constraints of the shape and size of the openings 303. In the example, two middle openings 303a provide a passageway through the lid 300, however, cavities 321 are disposed adjacent to the minor sides and do not provide passageway through the lid 300. The cavities 321 may be at least partially disposed above the refillable container 602 (shown in FIG. 10), and thus, facilitate trapping the insect within the refillable container 602.

The second openings 303b may be triangular in cross-sectional shape. Similarly, triangular shapes may make it more difficult for insects to escape the insect trap 100. The second openings 303b may also have an inward taper from the inlet 312 towards the outlet 310.

Additionally, some embodiments may include darker coloring around the plurality of openings 303 or on the exterior surface 308 on the top end 302 of the lid 300. Darker colors attract flying insects more effectively than light colors.

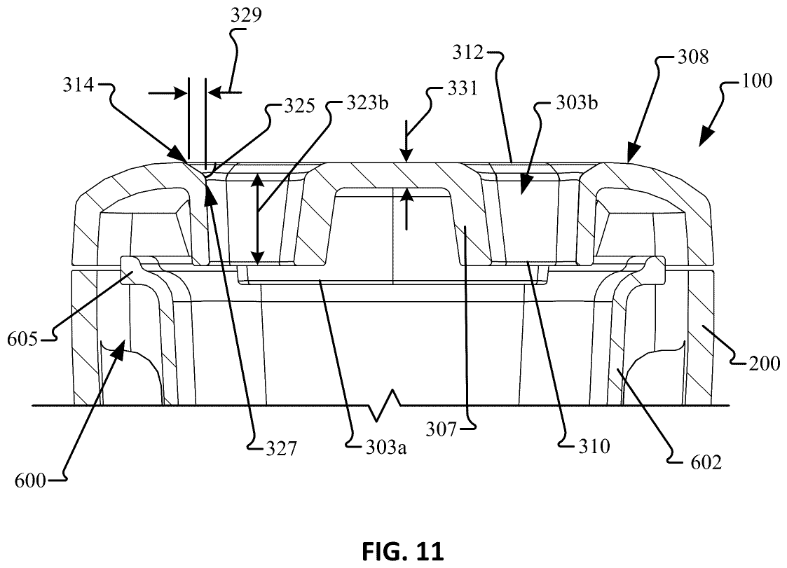

Turning now to FIGS. 10 and 11, FIG. 10 is a cross-sectional view of the insect trap 100 and FIG. 11 is another cross-sectional view of the insect trap 100. Each of the plurality of openings 303 has the inlet 312 at the exterior surface 308 of the lid 300 with the transition section 314 that creates an angled surface or chamfer, which can be advantageous for insect landing and then insect movement into the insect trap 100. The transition section 314 may be slightly curved in nature. A longitudinal distance 323a,b from the transition section 314 to the outlet 310 may be about 1 mm. In another example, the longitudinal distance 323a,b from the transition section 314 to the outlet 310 may be anywhere from about 0.5 mm to about 3 mm. The longitudinal distance 323a,b may vary based on the type of flying insect, the size of the insect trap 100, and other factors. In the example, the distance 323a of the first opening 303a is longer than the distance 323b of the second opening 323b. In other examples, the distances 323a,b may be equal as required or desired. In some embodiments, the disclosed trap is used in interior residential or household surfaces. The disclosed distances are suitable for such applications. Other embodiments are contemplated where the trap 100 is scaled to other sizes. For example, the trap could be larger to accommodate larger flies or for larger spaces such as a garage.

In embodiments, the outlet 310 of the plurality of openings 303 may at least partially extend into the top of the major walls of the first end 202 of the base 200. This configuration facilitates trapping the insects within the inset trap 100 and allowing the insect bait to emit smells and odors that flow out of the openings 303. The inlet 312 of the middle channels 307 may chamfered such that the transition section 314 of the inlet 312, directly adjacent the exterior surface 308, has an angle 325 between 15° and 45° relative to the exterior surface 308. In one embodiment, the angle may be about 30°. In the example, angle 325 is measured below a horizontal plane of the exterior surface 308 of the top end 302 of the lid 300 and the transition section 314 is directly adjacent to the exterior surface 308. In the example, the first and second openings 303a,b have a similar transition section 314 angle 325. In other examples, the first and second openings 303a,b may have different angles for the transition sections.

In one example, the chamfered surface may have two separate angles. First, a smaller angle 325 that is from about 15° and 45°, and then a sharper angle 327 located between the transition section 314 and the channel 307 that is between 45° and 90° and enables the centerline axis 305 of the openings 303 to be substantially parallel to the longitudinal axis 102 (shown in FIG. 2). The vertical orientation of the channels 307 of the openings 303 directs the insect into the inner cavity 600 of the base 200. The transition section 314 may have a horizontal length 329 that is approximately equal to or greater than a thickness 331 of the lid 300. The plurality of openings 303 may have a total opening area that is about half or less of a total surface area of the top end 302 of the lid 300 defined between the major and minor sides. This configuration allows for surface area for insects to land on while also providing openings for the insects to enter into the insect trap 100.

In embodiments, a vertical distance of the transition section 314 to the elongated middle channel 316 of each of the plurality of openings may be about 1 mm. In other examples, the vertical distance may be from about 0.25 mm to about 3.0 mm, and ranges in between.

Further, in embodiments the top end 302 of the lid 300 may have a different cross-sectional perimeter than the rest of the lid 300 due to the plurality of openings 303 that create the chamfer. The plurality of openings 303 may reduce the total surface area of the top end 302 of the lid 300.

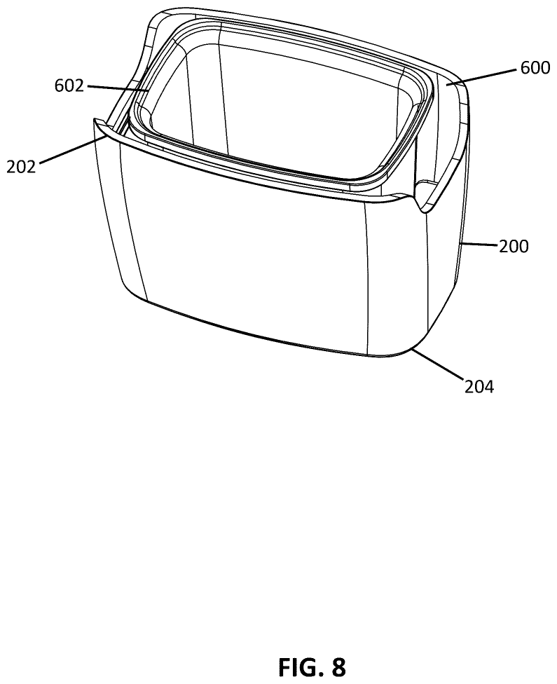

FIG. 8 is a perspective view of the base 200 and refillable container 602 of the insect trap 100. The base 200 of the insect trap 100 defines the inner cavity 600. The inner cavity 600 of the base 200 may be configured to house the refillable container 602. The refillable container 602 may be positioned such that a top 605 of the refillable container 602 extends higher than the first end 202 of the base 200 and as illustrated in FIGS. 10 and 11. As such, the outlets 310 of the openings 303 are configured to extend into the top 605 of the refillable container 602. The bottom of the refillable container 602 rests against the seat 210 of the base 200 (shown in FIG. 5A).

The refillable container 602 is positioned to sit higher in the insect trap 100 than the base 200, to ensure a proper distance between the outlets 310 of the lid 300, and the refillable container 602 housing an insect bait or attractant. The vertical distance between the outlets 310 and the insect bait or attractant may be at least the distance 323 of the middle channels 316 of the lid 300 or more so that it is less likely that the flying insect is able to escape once it enters the plurality of openings 303 and exits through the second opening 306 of the plurality of openings 303.

In embodiments, the liquid of the refillable container 602 may be any insect attractant or bait designed to lure the targeted flying insect. The insect trap 100 may be designed to facilitate the capture of a variety of flying insects, and different baits and attractants may be better suited for some flying insects versus others.

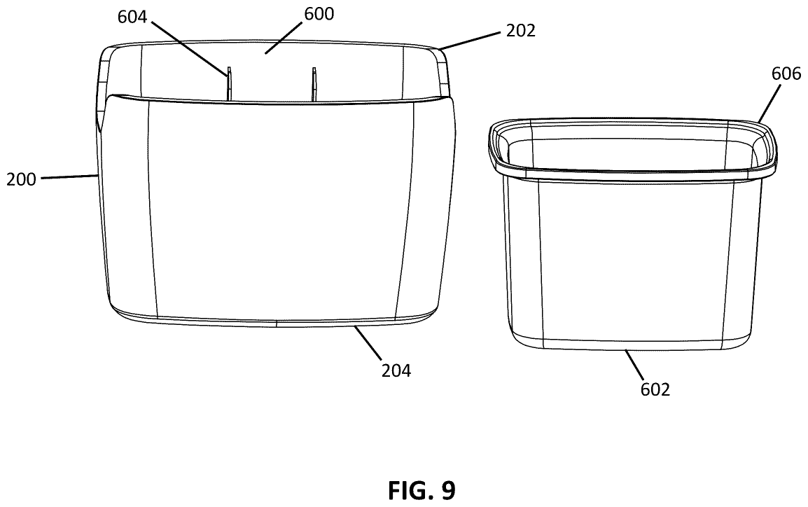

FIG. 9 is a perspective view of the base 200 of the insect trap 100, with the refillable container 602 removed from the inner cavity 600. In one example, the refillable container 602 is smaller than the base 200 of the insect trap 100, to facilitate the refillable container 602 being removably nested within the inner cavity 600 of the base 200. The refillable container 602 is easily removed to be refilled with an insect bait or attractant.

The refillable container 602 may have a lip 606 that extends further than the body of the refillable container 602. The lip 606 of the refillable container 602 may prevent insects that enter the insect trap 100, from getting stuck in the inner cavity 600 and between the base 200 and the refillable container 602, rather than falling into the liquid in the refillable container 602. The lip 606 of the refillable container 602 is situated to decrease the amount of space between the refillable container 602, and the first side 202 of the base 200. Without the lip 606, there may be a sizeable gap between the refillable container 602 and the plurality of walls (208A-D) of the base 200 that form the inner cavity 600. Additionally, the lip 606 may be used as a surface to seal the refillable container 602 with foil, prior to use.

In embodiments, the inner cavity 600 of the base 200 may have ribs 604 for receiving the refillable container 602 and positioning the refillable container 602 within the inner cavity 600. There may be one or more ribs 212 that mate with the refillable container 602 to secure it within the inner cavity 600. The ribs 212 are located on the plurality of walls (208A-D) of the base 200. The ribs 212 may be on any of the plurality of walls (208A-D).

In a preferred example, the refillable container 602 may be sold already filled with the liquid and sealed for easy replacement of the refillable container 602, and to avoid mess or spillage. The refillable container 602 may be filled with the liquid attractant, and sealed with foil or another suitable material that would attach to the lid 606. In another example, the insect bait or attractant liquid may be poured into the refillable container 602 to avoid waste, and to use the same refillable container 602 more than once. In another example, the refillable container 602 may be filled with granules formed of the concentrated insect attractant, and water may be added to activate the attractant and fill the refillable container 602 with liquid. In another example, a dropper or syringe may be used to drop liquid into the refillable container 602.

In other examples, insect bait or attractant liquid may be directly held within the base 200 and the refillable container 602 may not be needed.

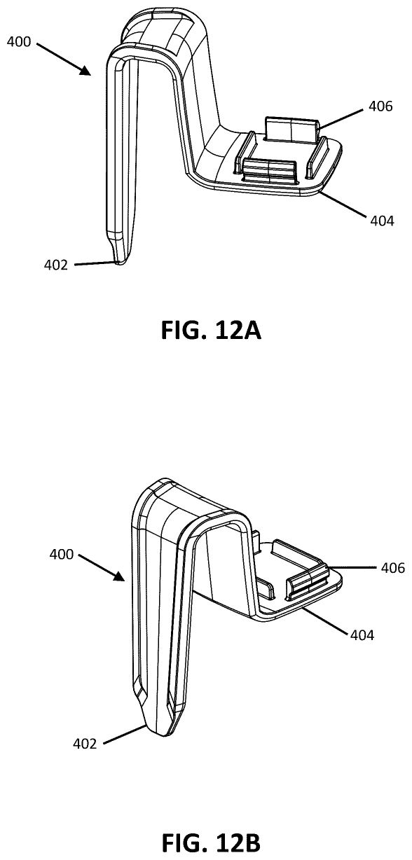

FIGS. 12-15 are perspective views of the post 500 and hook 400 for use with the insect trap 100 (shown in FIG. 1). Both the hook 400 and the post 500 are designed to facilitate situating the insect trap 100 in a variety of locations and positions.

The hook 400 may have a first end 402 and a second end 404. The first end 402 may be tapered such that the width of the first end 402 is smaller than the width of the second end 404. The first end 402 of the hook 400 is designed to be pushed over a surface first, to hang the insect trap 100 on a surface, windowsill, or another location. The hook 400 may have a rounded curvature between the first end 402 and the second end 404. The rounded curvature may be about 90°. The curvature of the hook 400 may vary depending on where the insect trap 100 will be hung, and to facilitate secure attachment.

In an embodiment, there may be several prongs 406 that extend from the second end 404 of the hook 400. The prongs 404 mate with the seat 210 (shown in FIG. 5A) of the base 200 to facilitate attachment to the insect trap 100. In one example and as seen in FIG. 12, there may be two prongs 406 to facilitate a snap fit connection within a corresponding recess within the seat 210 and two prongs 406 that facilitate alignment within the seat 210. In another example, there may be one or more prongs 406 to mate with the seat 210 of the base 200.

The post 500 may have a first end 502 configured to removably couple to the seat 210 of the base 200. Extending from the first end 502 of the post 500, to the second end 506, is a body 508 of the post 500. The body 508 may have a diameter that reduces in size towards the second end 504. The second end 504 of the post 500 may be pointed to allow for the post 500 to be pushed into the ground, or another surface that is malleable.

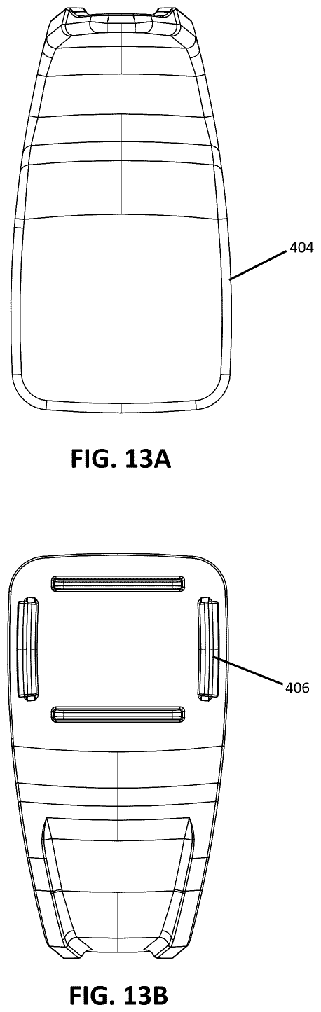

FIGS. 12A and 12B, and 13A and 13B are perspective views of the hook 400 for the insect trap 100, where the hook 400 has the first end 402, and the second end 404. The hook 400 may be in the shape of a “J,” with the second end 404 being the portion of the hook 400 that mates with the base 200 of the insect trap 100. The hook 400 removably couples to the seat 210 of the base 200 (both shown in FIG. 5A), so a user may remove the hook 400. This allows the insect trap 100 to be used in more than one environment and space because it can be used with or without the hook 400 or post 500. In the example, the hook 400 is configured to snap-fit connect to the base 200. In other examples, the hook 400 may be press-fit or otherwise removably coupled to the base 200.

The hook 400 couples to the seat 210 located on the second end 204 of the base 200. The second end 404 of the hook 400 may have one or more prongs 406 that latch to the sides of the seat 210, coupling the second end 404 of the hook to the second end 204 of the base.

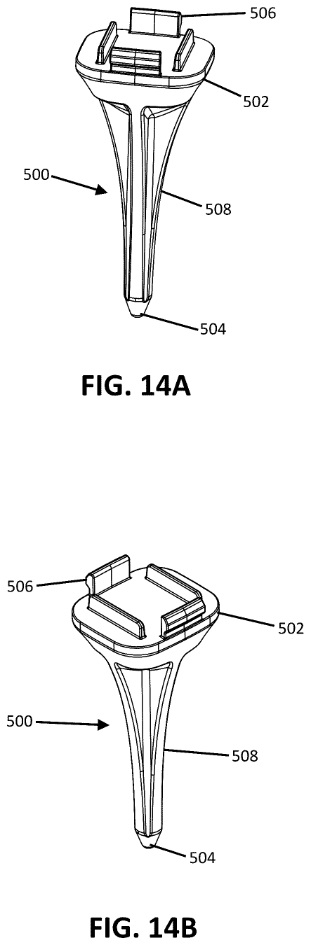

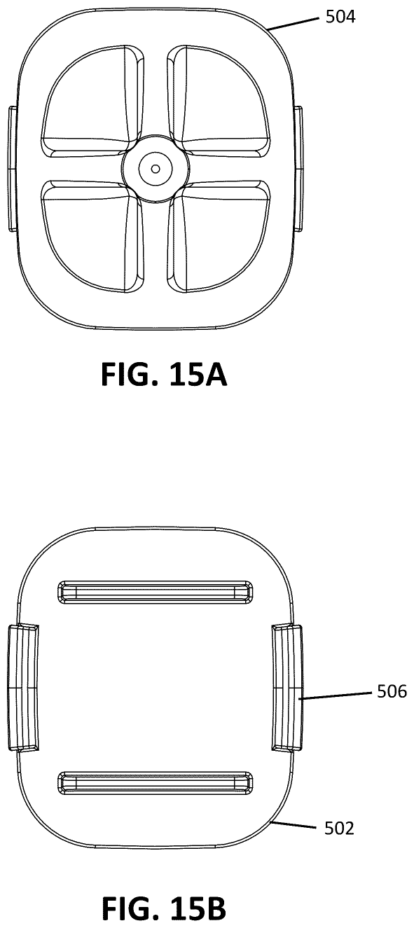

FIGS. 14A and 14B, and 15A and 15B are perspective views of the post 500 for the insect trap 100. The post 500 has the first end 502, a body 508 extending from the first end 502 to the second end 504, and one or more prongs 506. The first end 502 of the post 500 may have a larger diameter than the second end 504. The diameter of the post 500 may decrease along the body 508, moving from the first end 502 to the second end 504. The second end 504 may be tapered with a subtle point to facilitate pushing the second end 504 into a malleable surface. For example, the post 500 of the insect trap 100 may be pushed into soil outside, or into the soil of a house plant, or into another surface to have the insect trap 100 stand vertically.

The one or more prongs 506 on the first end 502 of the post 500 are configured to mate with the seat 210 of the second end 204 of the base 200 and similar to the hook 400 described above. The one or more prongs 506 removably couple the post 500, to the second end 204 of the base 200. The prongs 506 may be situated around the perimeter of the first end 502 of the post 500.

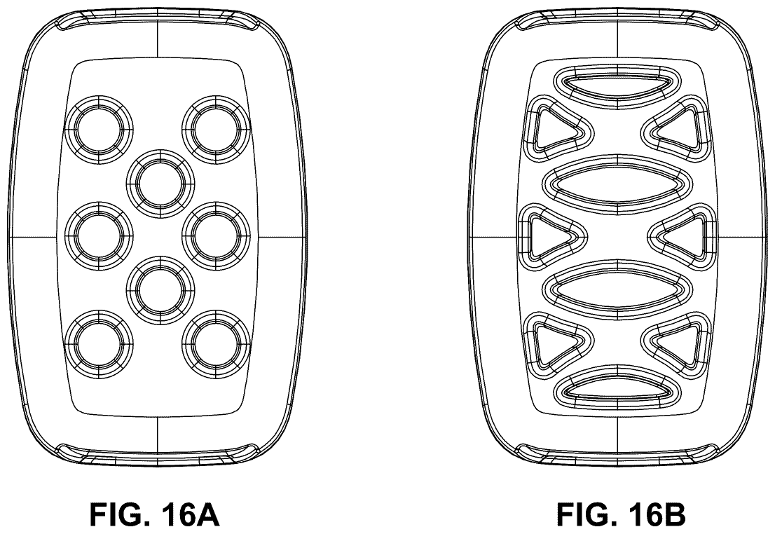

FIGS. 16A and 16B are perspective views of two embodiments of an insect trap top. The insect trap top in FIG. 16A features an 8-bubble design, where each of the 8 bubbles is a circular opening in the top. The insect trap in top in FIG. 16B features a lattice design. The tops in each of FIGS. 16 and 16B were used for the data collected in example 1 below.

In another embodiment, the trap may be scaled to be larger in size. If scaled, the insect trap may have a circular, rectangular, square, or another suitably shaped base. In a scaled version of the insect trap, the lid of the trap would remain the same, with the base being changeable in size, shape, or configuration.

The trap 100 may be made out of a number of materials such as high density polyethylene, low density polyethylene, polypropylene, polyethylene, polystyrene, polyethylene terephthalate, polyvinyl chloride, nylon, resin, Styrofoam, and the like. In some embodiments, the trap 100 is made out of biodegradable material such as paper, pulp, fiber, plant fiber, natural fiber, or cellulose material such as paper, cardstock, cardboard, molded paper, pressed paper, coated paper, and the like. In embodiments where the trap 100 is designed to be single use, it may be beneficial to make the trap out of a biodegradable material.

In use, the insect trap 100 may have advantages over other designs. In some aspects, the insect trap 100 can be used in a method of trapping flying insects. In the method, the trap is placed in a location and allowed to remain in the location for a period of time to trap flying insect. The trap either includes insect attractant, or insect attractant is added or refilled as needed.

### Examples

### Example 1—Comparison of Bubble and Lattice Shapes

Example 1 tested the effect of the shape of the openings in FIGS. 16A (bubble configuration) and 16B (lattice configuration) on fly catch. Three replicates were done for each of the bubble configuration and the lattice configuration. The traps contained 5 mL of an insect attractant with 0.95% sodium lauryl sulfate (30%), 15% corn syrup, 5% vinegar, 0.1% potassium sorbate in water.

For each test, 25 house flies (Musca domestica) were placed in an enclosure with the trap and monitored for 24 hours at 22° C. and 23% relative humidity. After 24 hours, mortality was assessed and recorded and averaged for the three replicates. Flies were considered dead if they were caught in the liquid insect attractant and unable to escape when the traps were opened. The results are provided in Table 1 below.

TABLE 1

| Configuration | Average 24 hr. Mortality (%) |
|---|---|
| Bubbles | 44% |
| Lattice | 93% |

The data in Table 1 indicates that the lattice shape was more effective than the bubble shape at attracting flies.

### Example 2—Effect of Trap Color on Fly Catch

The below tables illustrate the effect of the color of the trap on the number of flies caught. The test method for Example 2 was the same as the method in Example 1 but mortality was observed at 24 hours, 48 hours, or 72 hours depending on the test. For this test, the lattice trap shown in FIG. 16B was used. The column labeled “test” contains different variations of Pantone colors in one of three different configurations. In the first configuration, called “solid configuration”, a solid-colored trap was used, meaning that the lid and the base were the same color. In the second configuration, called the “exterior surface configuration,” the base and the lid were the same color but the exterior surface 308 is a different color. In the third configuration, called the “channel configuration,” the base and the lid were the same color but the openings on the lid specifically the openings 303, first opening 304, second opening 306, elongated channel 307, outlet 310, inlet 312, transition section 314, and middle channel 316, were a different color. The control tested a solid black trap with no insect attractant (empty trap). For the experimental tests, 5 mL of the insect attractant in Example 1 was used.

TABLE 2
24-hour mortality study

| | | Estimated | # of Flies in | 24 Hours | |
|---|---|---|---|---|---|
| Test | | # of Flies | Cage Final | # Dead | % Mortality |
| 1 | Control - Solid configuration; | 25 | 25 | 6 | 24% |
| | black (no insect attractant) | | | | |
| 2 | Control - Solid configuration; | 25 | 25 | 3 | 12% |
| | black (no insect attractant) | | | | |
| 3 | Solid configuration; black | 25 | 25 | 23 | 92% |
| 4 | Exterior surface configuration; | 25 | 25 | 19 | 76% |
| | Pantone 425 (dark gray) base and | | | | |
| | lid with black exterior surface | | | | |
| 5 | Channel configuration; Pantone | 25 | 25 | 23 | 92% |
| | 425 (dark gray) base and lid with | | | | |
| | black channel | | | | |
| 6 | Exterior surface configuration; | 25 | 26 | 22 | 88% |
| | Pantone 424 (medium gray) with | | | | |
| | Pantone 425 (dark gray) exterior | | | | |
| | surface | | | | |
| 7 | Exterior surface configuration; | 25 | 25 | 15 | 60% |
| | Pantone 423c (light gray) base | | | | |
| | and lid with black exterior surface | | | | |
| 8 | Channel configuration; Pantone | 25 | 25 | 10 | 40% |
| | 423c (light gray) base and lid with | | | | |
| | black channel | | | | |
| 9 | Solid configuration; Pantone Cool | 25 | 25 | 13 | 52% |
| | gray 7 | | | | |

TABLE 3
48-hour mortality study

| | | Estimated | # of Flies in | 48 Hours | |
|---|---|---|---|---|---|
| Test | | # of Flies | Cage Final | # Dead | % Mortality |
| 10 | Control - Solid configuration; black | 25 | 25 | 7 | 28% |
| | (no insect attractant) | | | | |
| 11 | Control - Solid configuration; black | 25 | 25 | 5 | 20% |
| | (no insect attractant) | | | | |
| 12 | Solid configuration; black | 25 | 25 | 24 | 96% |
| 13 | Exterior surface configuration; | 25 | 25 | 20 | 80% |
| | Pantone 425 (dark gray) with black | | | | |
| | exterior surface | | | | |
| 14 | Channel configuration; Pantone 425 | 25 | 25 | 23 | 92% |
| | (dark gray) with black channel | | | | |
| 15 | Exterior surface configuration; | 25 | 26 | 24 | 92% |
| | Pantone 424 (medium gray) with | | | | |
| | Pantone 425 (dark gray) exterior | | | | |
| | surface | | | | |
| 16 | Exterior surface configuration; | 25 | 25 | 21 | 84% |
| | Pantone 423c (light gray) with black | | | | |
| | exterior surface | | | | |
| 17 | Channel configuration; Pantone | 25 | 25 | 14 | 56% |
| | 423c (light gray) with black channel | | | | |
| 18 | Solid configuration; Pantone Cool | 25 | 25 | 14 | 56% |
| | gray 7 | | | | |

TABLE 4
24-hour mortality study

| | | | | 24 Hours | | |
|---|---|---|---|---|---|---|
| | | Estimated # | # of Flies in | | | Average % |
| Test | | of Flies | Cage Final | # Dead | % Mortality | Mortality |
| 19 | Control - Solid | 25 | 24 | 0 | 0% | 3% |
| | configuration; black | | | | | |
| | (no insect attractant) | | | | | |
| 20 | Control - Solid | 25 | 25 | 1 | 4% | |
| | configuration; black | | | | | |
| | (no insect attractant) | | | | | |
| 21 | Control - Solid | 25 | 24 | 1 | 4% | |
| | configuration; black | | | | | |
| | (no insect attractant) | | | | | |
| 22 | Solid configuration; | 25 | 25 | 7 | 28% | 45% |
| | black | | | | | |
| 23 | Solid configuration; | 25 | 25 | 15 | 60% | |
| | black | | | | | |
| 24 | Solid configuration; | 25 | 23 | 11 | 48% | |
| | black | | | | | |
| 25 | Exterior surface | 25 | 24 | 5 | 21% | 30% |
| | configuration; | | | | | |
| | Pantone 425 (dark | | | | | |
| | gray) with black | | | | | |
| | exterior surface | | | | | |
| 26 | Exterior surface | 25 | 25 | 5 | 20% | |
| | configuration; | | | | | |
| | Pantone 425 (dark | | | | | |
| | gray) with black | | | | | |
| | exterior surface | | | | | |
| 27 | Exterior surface | 25 | 26 | 13 | 50% | |
| | configuration; | | | | | |
| | Pantone 425 (dark | | | | | |
| | gray) with black | | | | | |
| | exterior surface | | | | | |
| 28 | Channel | 25 | 24 | 6 | 25% | 45% |
| | configuration; | | | | | |
| | Pantone 425 (dark | | | | | |
| | gray) with black | | | | | |
| | channel | | | | | |
| 29 | Channel | 25 | 24 | 15 | 63% | |
| | configuration; | | | | | |
| | Pantone 425 (dark | | | | | |
| | gray) with black | | | | | |
| | channel | | | | | |
| 30 | Channel | 25 | 25 | 12 | 48% | |
| | configuration; | | | | | |
| | Pantone 425 (dark | | | | | |
| | gray) with black | | | | | |
| | channel | | | | | |
| 31 | Solid configuration; | 25 | 23 | 5 | 22% | 35% |
| | Pantone 425 | | | | | |
| 32 | Solid configuration; | 25 | 24 | 17 | 71% | |
| | Pantone 425 | | | | | |
| 33 | Solid configuration; | 25 | 25 | 3 | 12% | |
| | Pantone 425 | | | | | |

TABLE 5
48-hour mortality test

| | | | # of Flies | 72 Hours | | |
|---|---|---|---|---|---|---|
| | | Estimated | in Cage | | | Average % |
| Test | | # of Flies | Final | # Dead | % Mortality | Mortality |
| 34 | Control - Solid | 25 | 24 | 1 | 4% | 6% |
| | configuration; | | | | | |
| | black (no insect | | | | | |
| | attractant) | | | | | |
| 35 | Control - Solid | 25 | 25 | 1 | 4% | |
| | configuration; | | | | | |
| | black (no insect | | | | | |
| | attractant) | | | | | |
| 36 | Control - Solid | 25 | 24 | 2 | 8% | |
| | configuration; | | | | | |
| | black (no insect | | | | | |
| | attractant) | | | | | |
| 37 | Solid | 25 | 25 | 20 | 80% | 86% |
| | configuration; | | | | | |
| | black | | | | | |
| 38 | Solid | 25 | 25 | 24 | 96% | |
| | configuration; | | | | | |
| | black | | | | | |
| 39 | Solid | 25 | 23 | 19 | 83% | |
| | configuration; | | | | | |
| | black | | | | | |
| 40 | Exterior surface | 25 | 24 | 13 | 54% | 69% |
| | configuration; | | | | | |
| | Pantone 425 | | | | | |
| | (dark gray) with | | | | | |
| | black exterior | | | | | |
| | surface | | | | | |
| 41 | Exterior surface | 25 | 25 | 22 | 88% | |
| | configuration; | | | | | |
| | Pantone 425 | | | | | |
| | (dark gray) with | | | | | |
| | black exterior | | | | | |
| | surface | | | | | |
| 42 | Exterior surface | 25 | 26 | 17 | 65% | |
| | configuration; | | | | | |
| | Pantone 425 | | | | | |
| | (dark gray) with | | | | | |
| | black exterior | | | | | |
| | surface | | | | | |
| 43 | Channel | 25 | 24 | 16 | 67% | 79% |
| | configuration; | | | | | |
| | Pantone 425 | | | | | |
| | (dark gray) with | | | | | |
| | black channel | | | | | |
| 44 | Channel | 25 | 24 | 22 | 92% | |
| | configuration; | | | | | |
| | Pantone 425 | | | | | |
| | (dark gray) with | | | | | |
| | black channel | | | | | |
| 45 | Channel | 25 | 25 | 20 | 80% | |
| | configuration; | | | | | |
| | Pantone 425 | | | | | |
| | (dark gray) with | | | | | |
| | black channel | | | | | |
| 46 | Solid | 25 | 23 | 15 | 65% | 72% |
| | configuration; | | | | | |
| | Pantone 425 | | | | | |
| | (dark gray) | | | | | |
| 47 | Solid | 25 | 24 | 23 | 96% | |
| | configuration; | | | | | |
| | Pantone 425 | | | | | |
| | (dark gray) | | | | | |
| 48 | Solid | 25 | 25 | 14 | 56% | |
| | configuration; | | | | | |
| | Pantone 425 | | | | | |
| | (dark gray) | | | | | |

TABLE 6
72-hour mortality test

| | | | | 72 Hours | | |
|---|---|---|---|---|---|---|
| | | Estimated | # of Flies in | | % | Average % |
| Test | | # of Flies | Cage Final | # Dead | Mortality | Mortality |
| 49 | Control - Solid | 25 | 24 | 2 | 8% | 16% |
| | configuration; | | | | | |
| | black (no insect | | | | | |
| | attractant) | | | | | |
| 50 | Control - Solid | 25 | 25 | 5 | 20% | |
| | configuration; | | | | | |
| | black (no insect | | | | | |
| | attractant) | | | | | |
| 51 | Control - Solid | 25 | 24 | 5 | 21% | |
| | configuration; | | | | | |
| | black (no insect | | | | | |
| | attractant) | | | | | |
| 52 | Solid | 25 | 25 | 24 | 96% | 93% |
| | configuration; | | | | | |
| | black | | | | | |
| 53 | Solid | 25 | 25 | 24 | 96% | |
| | configuration; | | | | | |
| | black | | | | | |
| 54 | Solid | 25 | 23 | 20 | 87% | |
| | configuration; | | | | | |
| | black | | | | | |
| 55 | Exterior surface | 25 | 24 | 15 | 63% | 76% |
| | configuration; | | | | | |
| | Pantone 425 | | | | | |
| | (dark gray) with | | | | | |
| | black exterior | | | | | |
| | surface | | | | | |
| 56 | Exterior surface | 25 | 25 | 24 | 96% | |
| | configuration; | | | | | |
| | Pantone 425 | | | | | |
| | (dark gray) with | | | | | |
| | black exterior | | | | | |
| | surface | | | | | |
| 57 | Exterior surface | 25 | 26 | 18 | 69% | |
| | configuration; | | | | | |
| | Pantone 425 | | | | | |
| | (dark gray) with | | | | | |
| | black exterior | | | | | |
| | surface | | | | | |
| 58 | Channel | 25 | 24 | 16 | 67% | 84% |
| | configuration; | | | | | |
| | Pantone 425 | | | | | |
| | (dark gray) with | | | | | |
| | black channel | | | | | |
| 59 | Channel | 25 | 24 | 24 | 100% | |
| | configuration; | | | | | |
| | Pantone 425 | | | | | |
| | (dark gray) with | | | | | |
| | black channel | | | | | |
| 60 | Channel | 25 | 25 | 21 | 84% | |
| | configuration; | | | | | |
| | Pantone 425 | | | | | |
| | (dark gray) with | | | | | |
| | black channel | | | | | |
| 61 | Solid | 25 | 23 | 18 | 78% | 82% |
| | configuration; | | | | | |
| | Pantone 425 | | | | | |
| | (dark gray) | | | | | |
| 62 | Solid | 25 | 24 | 23 | 96% | |
| | configuration; | | | | | |
| | Pantone 425 | | | | | |
| | (dark gray) | | | | | |
| 63 | Solid | 25 | 25 | 18 | 72% | |
| | configuration; | | | | | |
| | Pantone 425 | | | | | |
| | (dark gray) | | | | | |

The results of the above study showed that on average, flying insects were attracted to dark-colored surfaces. In examples, the entire lid could be dark-colored (for example, black). In additional examples, only the plurality of openings/channels, or the exterior surface may be dark-colored.

Variations in design and color of the top may be selected based on the type of flying insect that the trap is targeted for, or other specific objectives.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, may not be included or may be combined with other features.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about” shall mean plus or minus ten percent.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed:

1. An insect trap comprising:
a base including:
a first end and an opposite second end defining a longitudinal axis; and
a plurality of walls extending between the first end and the second end, wherein an inner cavity is defined by the plurality of walls and the second end, the inner cavity configured to receive insect bait; and
a lid configured to couple to the first end of the base and enclose the inner cavity, the lid defining a plurality of openings allowing access into the inner cavity, each of the plurality of openings having an inlet end defined on an exterior surface of the lid, an outlet end, and an elongated middle channel section extending between the inlet end and the outlet end,
wherein the outlet end of the plurality of openings at least partially extends into the first end of the base; and
wherein the inlet end of the plurality of channels is chamfered such that a transition section of the inlet end, directly adjacent the exterior surface, has an angle between 15° and 45° relative to the exterior surface.

2. The insect trap of claim 1, wherein the transition section of the inlet end has a 30° angle relative to the exterior surface.

3. The insect trap of claim 1, wherein an opening area of the inlet end at the transition section is larger than an opening area of the outlet end.

4. The insect trap of claim 1, wherein the plurality of openings comprise at least a first opening and a second opening, the first opening having a different shape and size than the second opening.

5. The insect trap of claim 1, wherein the lid has a top end that defines the plurality of openings, wherein the plurality of openings are less than half of a total surface area of the top end.

6. The insect trap of claim 1, wherein the second end of the base defines an exterior cavity, the insect trap further comprising a post configured to removably couple to the base at the exterior cavity.

7. The insect trap of claim 1, wherein the second end of the base defines an exterior cavity, the insect trap further comprising a hook configured to removably couple to the base at the exterior cavity.

8. The insect trap of claim 7, wherein the hook at least partially extends along one of the plurality of walls of the base.

9. The insect trap of claim 1, wherein the elongated middle channel section of the plurality of openings taper inward from the inlet end towards the outlet end.

10. The insect trap of claim 1, wherein the plurality of openings extend substantially parallel to the longitudinal axis.

11. The insect trap of claim 1, wherein the lid comprises latches to removably couple to the first end of the base.

12. The insect trap of claim 1, further comprising a refillable container configured to hold the insect bait, the container portion disposed within the inner cavity of the base, wherein the outlet end of the plurality of openings extend into the container portion.

13. The insect trap of claim 4, wherein the elongated middle channel section of the first opening has a longer longitudinal length than the elongated middle channel section of the second opening.

14. An insect trap comprising:
a base including:
a first end and an opposite second end defining a longitudinal axis; and
a plurality of walls extending between the first end and the second end, wherein the second end and the plurality of wall define;
a refillable container removably disposed within the inner cavity of the base, the refillable container configured to hold insect bait, wherein an open top end of the refillable container is positioned higher than the first end of the base;
a lid configured to removably couple to the first end of the base and enclosing the interior cavity, the lid defining a plurality of openings allowing access to the inner cavity, each of the plurality of openings having an inlet end at an exterior surface of the lid, an outlet end, and an elongate channel extending between the inlet end and the outlet end,
wherein each of the plurality of openings extend substantially parallel to the longitudinal axis with the outlet end disposed within the refillable container, and
wherein the inlet end of the plurality of openings is larger than the outlet end.

15. The insect trap of claim 14, wherein the inlet end is chamfered and has a transition section adjacent the exterior surface with an angle of about 30° relative to the exterior surface.

16. The insect trap of claim 14, wherein at least some of the plurality of openings are ellipses.

17. The insect trap of claim 14, wherein the lid has a thickness, a longitudinal length of the elongate channel of the plurality of openings larger than the thickness of the lid.

18. The insect trap of claim 14, wherein the lid does not form a seal against the open top end of the refillable container.

19. The insect trap of claim 14, wherein the second end of the base comprises a seat, the seat supporting the refillable container.

20. The insect trap of claim 19, wherein the seat defines an exterior cavity, the insect trap further including a post or a hook, each configured to couple to the seat at the second end of the base in a snap fit connection.

21. The insect trap of claim 14, wherein at least a portion of the exterior surface of the lid is a dark color.
